(19) United States
(12) Patent Application Publication
(10) Pub. No.: US 2011/0094472 A1
(43) Pub. Date: Apr. 28, 2011

(54) COMPONENT UNIT FOR A FUEL SYSTEM OF AN INTERNAL COMBUSTION ENGINE AND INTERNAL COMBUSTION ENGINE

(75) Inventors: Stefan SCHREINER, Hofheim (DE); Michael BRUDY, Zwingenberg (DE); Arno NOE, Hanau (DE)

(73) Assignee: GM GLOBAL TECHNOLOGY OPERATIONS, INC., Detroit, MI (US)

(21) Appl. No.: 12/910,392

(22) Filed: Oct. 22, 2010

(30) Foreign Application Priority Data
Oct. 22, 2009 (DE) 102009050337.4

(51) Int. Cl. F02M 61/14

(52) U.S. Cl. 123/294

(57) ABSTRACT

A component unit is provided for a fuel system of an internal combustion engine, in particular for use in an internal combustion engine having direct injection, having at least one injector, which injects fuel, and/or at least one mounting, on which at least one injector, which injects fuel, is fixable, and having at least one fuel line, using which the injector or the mounting is connectable to a fuel distributor. It is provided that the injector or the mounting is connected to the fuel line using a plug connection. Furthermore, at least one positioning aid is provided, which holds the injector or the mounting in a specified location.

### CROSS-REFERENCE TO RELATED APPLICATION

This application claims priority to German Patent Application No. 102009050337.4, filed Oct. 22, 2009, which is incorporated herein by reference in its entirety.

### TECHNICAL FIELD

The invention relates to a component unit for a fuel system of an internal combustion engine, in particular for use in an internal combustion engine having direct injection, having at least one injector, which injects fuel, and/or at least one mounting, on which at least one injector, which injects fuel, is fixable, and having at least one fuel line, using which the injector or the mounting are connectable to a fuel distributor. Furthermore, the invention relates to an internal combustion engine, in particular for use in a motor vehicle.

### BACKGROUND

Component units of the type claimed here typically comprise multiple injection valves or injectors for injecting the fuel into the combustion chamber of the internal combustion engine or at least mountings for the injectors and fuel lines, using which the injectors are connectable to a fuel distributor, for example, in the form of a distribution pipe.

Such component units are frequently used in gasoline engines having direct injection, in which, because of restricted installation space, the fuel distributor cannot be situated directly in the area of the injectors in many cases. The fuel lines allow the fuel distributor to be located at almost any desired spatial distance to the injectors.

In order to nonetheless keep the production costs of the component units as low as possible, in spite of their relatively many individual parts, the fuel lines are connected to the injectors or the mountings using soldering. It is also typical to connect the fuel lines to the fuel distributor using soldering. However, such strong heating occurs due to the soldering that the components change in their shape and/or location to one another in an undesired manner. This warpage of the components makes it more difficult to install the injectors in the cylinder head, which only permits extremely small changes in the shape and/or location of the injectors because of specified narrow tolerances. Therefore, such large tensions frequently occur upon the installation of the injectors and/or the component unit that the injectors are no longer completely functional.

It is therefore at least one object to provide a component unit having the features cited at the beginning, which can be installed largely without tension on the internal combustion engine in spite of specified narrow tolerances. Furthermore, a corresponding internal combustion engine is to be proposed. In addition, other objects, desirable features and characteristics will become apparent from the subsequent summary and detailed description, and the appended claims, taken in conjunction with the accompanying drawings and this background.

### SUMMARY

The component unit is suitable for a fuel system of an internal combustion engine. The component unit is preferably suitable for use in an internal combustion engine having direct injection, in particular for gasoline engines having direct injection. A use of the component unit in diesel engines is also conceivable. The component unit has at least one injector, which injects fuel, and/or at least one mounting, on which at least one injector, which injects fuel, is fixable. An injector is to be understood in the meaning of the invention as an element for injecting the fuel into the combustion chamber of the internal combustion engine. The injection element or injector can be implemented as a nozzle device or valve device.

The component unit further has at least one fuel line, using which the injector and/or the mounting are connectable to a fuel distributor. Through the fuel line, the fuel distributor can be situated spatially spaced apart from the injector, so that an optimum integration of injector and fuel distributor is also made possible in internal combustion engines having a very small amount of available installation space. A fuel line is preferably assigned to each injector.

It is provided according to the invention that the injector or the mounting is connected to the fuel line using a plug connection. Through this measure, location and shape changes on the fuel line, the injector, and/or the mounting due to thermal influences may be significantly reduced. The plugging together is preferably performed in the cold state of the components. In this cold state, changes of the shape and location of the components due to any thermal influences may be prevented. Even extremely small specified installation tolerances may thus be maintained during installation of the component unit, in particular the injectors, in the internal combustion engine. Installation of the component unit without jamming is thus possible through the plugging of the components of the component unit.

According to one embodiment of the invention, it is provided that the injector or the mounting is connected to the fuel line using the plug connection in a friction-locked, formfitting, and/or glued manner. A fixed connection of fuel line and mounting and/or injector is thus ensured. This is performed in a simple and cost-effective manner, in that the connection of fuel line and injector and/or mounting can be generated by friction lock, for example, in that the fuel lines are plugged together with the injectors and/or mountings by clamping and/or pressing. Formfitting and/or materially-bonded plug connections are also conceivable, of course.

Fundamentally, a connection of fuel line and injector can also be implemented not only in a formfitting and/or friction-locked manner, but rather alternatively or additionally also by material bonding, in particular by thermal material bonding, for example, soldering and welding. It is decisive that the connection is sealed and leakage of fuel is thus prevented.

It suggests itself that the plug connection be formed by the end of the fuel line which is inserted into a receptacle of the injector or mounting. The plug connection can thus be implemented in a particularly simple manner, because changes are not required on the part of the fuel line, in order to be able to implement the plug connection. The end of the fuel line, which is already provided in any case, is merely inserted into the receptacle of the injector and/or mounting. Furthermore, a component unit is subsequently presented for achieving the object. The component unit is distinguished, inter alia, by at least one positioning aid, which holds the injector or the mounting in a specified location.

Through this measure, the injector can be brought exactly into such a location that even in the case of specified extremely small tolerances on the part of the internal combustion engine, a perfect installation, in particular without tensions, of the injector in or on the cylinder head is ensured. Fuel line and injector or fuel line and mounting may thus be thermally materially bonded to one another, in particular using welding and/or soldering, because a change of the specified location of the injector or the mounting as a result of possible warpage occurring during the heating is prevented by the positioning aid. It suggests itself in particular that the positioning aid hold the injector and/or the mounting in a specified installation location with respect to the internal combustion engine.

If at least two injectors, which inject fuel, and/or mountings for the injectors are provided, it suggests itself that the positioning aids hold the injectors and/or the mountings at a specified distance to one another. The fuel lines having the injectors situated thereon or the fuel lines having the injectors situated thereon via mountings may thus be brought into a position to one another such that installation of the component unit in the internal combustion engine can be implemented without jamming occurring upon installation of multiple injectors in the cylinder head of the internal combustion engine.

The component unit having the positioning aid can be combined with the above-mentioned component unit having the plug connection, so that a component unit can be implemented in which the fuel lines are connected the mountings and/or the injectors using plug connections and which has the positioning aid.

According to one embodiment of the invention, it is provided that the positioning aid is fixable on the internal combustion engine. Positioning of the mounting and/or injectors is thus permanently achieved, so that the component unit can be removed from the internal combustion engine and subsequently, while maintaining the positioning of the injectors, can be reinstalled using the same positioning aid in the internal combustion engine while maintaining the specified positions. Upon the reinstallation of the injectors, tilting or jamming of the injectors in relation to the cylinder head of the internal combustion engine which receives the injectors is again prevented because of the positioning aid.

The positioning aid preferably has through holes for fixation and/or alignment on the internal combustion engine using pins, screws, or similar connection means which engage in the through holes. The positioning aid is fixable in a particularly simple and cost-effective manner on the internal combustion engine using the through holes and can be uninstalled from the internal combustion engine again if screw means are used, for example. In addition, an alignment of the positioning aid on the internal combustion engine during the installation is made possible using the pins, so that an exact orientation of the positioning aid with respect to a specified location on the internal combustion engine can be implemented. The positioning aid can also be fixed and/or aligned or positioned on the internal combustion engine using shaped elements of arbitrary type.

According to a preferred embodiment of the invention, it is provided that the positioning aid is formed by at least one spacer, which connects the injectors or mountings to one another. The spacer preferably has sections which receive the injectors or mountings. At least one weblike section of the spacer is preferably situated between the sections which receive the injectors or mountings. A secure connection of mounting or injector and spacer is provided by the sections which receive the injectors or mountings, so that positioning or orientation of the injectors permanently in a specified location is thus already made possible in a simple and precise manner. In that the sections having the injectors are each connected to one another by at least one weblike section, the injectors are brought into a specified location to one another. An optimization with respect to weight is performed by the weblike implementation of the sections, so that the function of the positioning aid is implemented by the spacer using the least possible material. The spacer has a particularly stable form if at least two weblike sections, which preferably form a frame, lie between the sections for receiving the injectors or mountings.

According to another embodiment of the invention, it is provided that the at least one injector and/or the at least one mounting, the at least one fuel line, the at least one positioning aid, and optionally the fuel distributor form a pre-installable unit. Installation and testing time in the engine factory can thus be significantly reduced, because the parts of the component unit may be delivered already pre-installed and they may then be installed in one work step. The pre-installed unit can already be tested separately, for example, for tightness, before the installation in the internal combustion engine.

It can also be provided that the at least one injector and/or the at least one mounting, the at least one fuel line, and optionally the fuel distributor form a pre-installable unit.

The positioning aid, in particular the spacer, can be formed by a shaped element, such as a screw or a pin, which engages in a rib or recess of the internal combustion engine, for example.

The fuel line can be connected to the fuel distributor using a plug connection, screw connection, or soldered connection. A pre-installation of the fuel lines with the injectors and/or mountings can thus be performed, the pre-installed unit then being able to be assembled with the fuel distributor in a simple manner on location on the internal combustion engine, in that, for example, the fuel lines are plugged onto the fuel distributor or screwed together. Soldering of the parts to one another is also possible, of course.

Fundamentally, a connection of fuel line and fuel distributor can be implemented not only in a formfitting and/or friction-locked manner, but rather alternatively or additionally also by material bonding, in particular by thermal material bonding, such as soldering and welding. It is decisive that the connection is tight and thus leakage of fuel is prevented.

According to a further idea of the invention, an internal combustion engine is provided, in particular for use in a motor vehicle. The internal combustion engine has at least one component unit of the above-described type.

Further goals, advantages, features, and possible applications of the present application result from the following description of two exemplary embodiments on the basis of the drawing. All features which are described and/or shown in the figures form the subject matter of the present invention per se or in arbitrary reasonable combination, even independently of their summary in the claims or what they refer back to.

### BRIEF DESCRIPTION OF THE DRAWINGS

The present invention will hereinafter be described in conjunction with the following drawing figures, wherein like numerals denote like elements, and:

FIG. 1 shows an embodiment of a component unit for a fuel system of an internal combustion engine in a perspective view;

FIG. 2 shows a further embodiment of a component unit for a fuel system of an internal combustion engine in a perspective exploded view; and

FIG. 3 shows the component unit from FIG. 2 as a detail in the area of a mounting for an injection valve.

### DETAILED DESCRIPTION

The following detailed description is merely exemplary in nature and is not intended to limit application and uses. Furthermore, there is no intention to be bound by any theory presented in the preceding background or summary or the following detailed description.

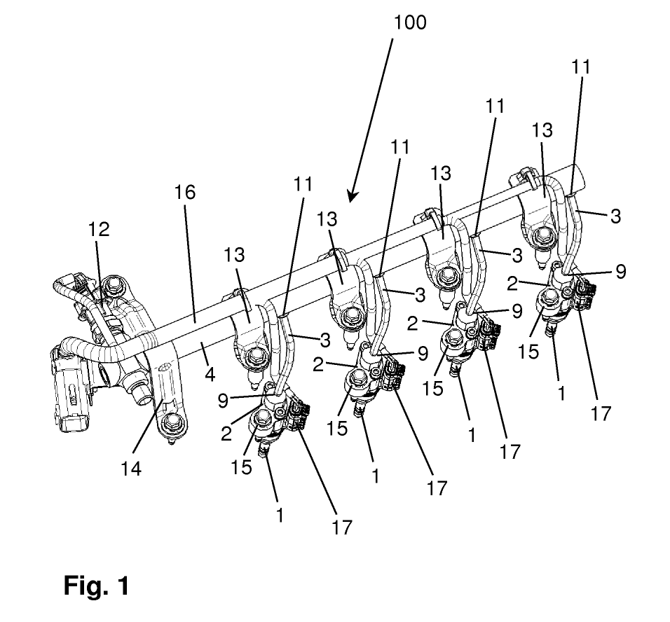

FIG. 1 shows in a schematic view, a component unit 100 for a fuel system of an internal combustion engine, in particular for use in gasoline engines having direct injection. The component unit 100 is pre-installed as a module and preferably tightness tested. The component unit 100 is thus prepared as a finished module for final assembly on an internal combustion engine (not shown).

The component unit 100 has four injectors 1, which inject fuel, and which each are held by a mounting 2. The number of the injectors is dependent on the construction of the internal combustion engine. Therefore, component units having one, two, three, or even more than four injectors are also conceivable.

The component unit 100 further has fuel lines 3, which are each connected at one end to a mounting 2 and at their other end to a fuel distributor 4. The fuel lines 4 are preferably inserted into the associated mounting 2, preferably in a friction-locked manner, so that the fuel lines 4 are each connected to the associated mounting 2 using a plug connection 9. In this manner, a fixed connection can be implemented between mounting 2 and fuel line 3, for example, in that the fuel line 3 is inserted into the associated mounting 2 while generating a clamp connection 11. The connection between the fuel line 3 and the fuel distributor 4 can also be implemented in the same manner as the connection between the fuel line 3 and the associated mounting 2.

The connection of the fuel lines 3 to the respective associated mounting 2 and the attachment of the fuel lines 3 on the fuel distributor 4 can also be implemented using soldering as a soldered connection 11, screw connections, or other types of connection. Various types of connection may also be provided. For example, a plug connection can be implemented between the fuel line 3 and the associated mounting 2, and a screw connection and/or soldered connection can be provided between the same fuel line 3 and the fuel distributor 4. The multiple provided fuel lines 3 are also connectable to the fuel distributor 4 by different types of connection, so that a fixed and stable connection is implemented.

The fuel distributor 4 is a hollow body, preferably implemented as a pipe, whose one end has the inlet for the fuel and whose other end of the pipe is closed. For example, a pressure sensor 12 can be situated on the end of the pipe having the inlet for the fuel, in order to be able to ascertain the pressure of the fuel in the fuel distributor 4 and be able to control and/or regulate the pressure in the fuel distributor 4 using a downstream regulating device (not shown). The fuel distributor can also be a hollow body having a round, oval, and/or polygonal cross-section. Combinations of such cross-sections over the length of the hollow body are also possible. The hollow body can be cast.

The fuel distributor 4 is installable using fasteners 13, for example, like clamps or holders, on the cylinder head (not shown) of the internal combustion engine. In order to prevent any oscillations at the intake of the fuel distributor 4 during the operation of the internal combustion engine, the fuel distributor 4 has an additional fastener 14 in the area of the intake for the fuel, for example, like a further clamp, which is fixable on the cylinder head (not shown) of the internal combustion engine.

Fasteners 15 are provided on the mountings 2 and/or injectors 1, using which a fixation on the internal combustion engine (not shown), in particular the cylinder head of the internal combustion engine, can be implemented. The fasteners 15 may be implemented by through holes, for example, through which screw means or similar fastening means may be inserted and fixed against the internal combustion engine (not shown).

Furthermore, a cable set 16 can be assigned to the component unit 100, which, for the electrical contacting, connects a plug 17 of a respective injector 1 via a corresponding electrical line. The cable set 16 can have a plug (not shown) or a corresponding bush, using which the cable set 16 is connectable to an associated bush or plug of the motor vehicle (not shown).

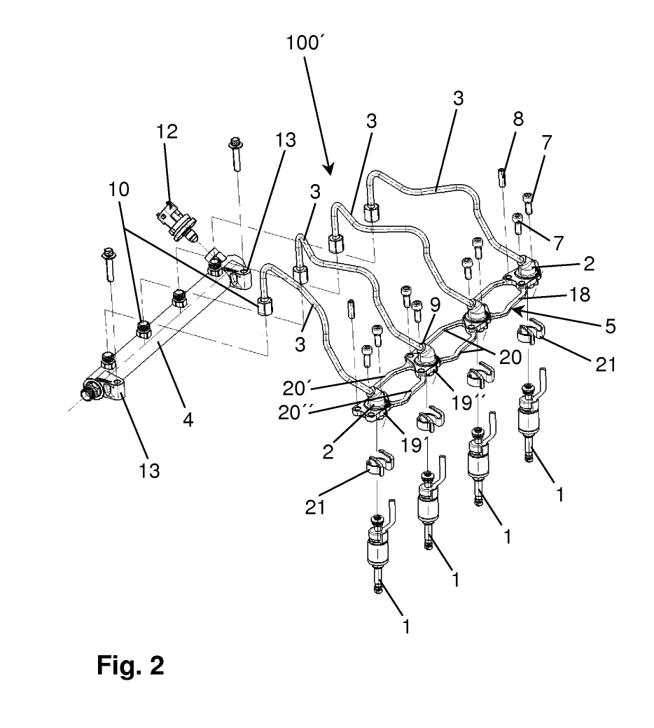

FIG. 2 shows in a schematic view, a further embodiment of a component unit 100′ for a motor vehicle of an internal combustion engine, in particular for use in gasoline engines having direct injection. Components of the component unit 100′ according to FIG. 2 which are identical or functionally identical to the component unit 100 according to FIG. 1 are provided with the same reference numerals; in this regard, reference is made to the description of FIG. 1.

The component unit 100′ according to FIG. 2 differs from the component unit 100 according to FIG. 1, inter alia, in that the component unit 100′ has at least one positioning aid 5, which holds the injectors 1 and/or the mountings 2 in a specified location. The positioning aid 5 preferably holds the injectors 1 and/or the mountings 2 in a specified installation location with respect to the internal combustion engine (not shown), the injectors 1 and/or the mountings 2 being held at a specified distance to one another. For this purpose, the positioning aid 5 is formed by at least one spacer 18, which connects the injectors 1 and/or mountings 2 to one another.

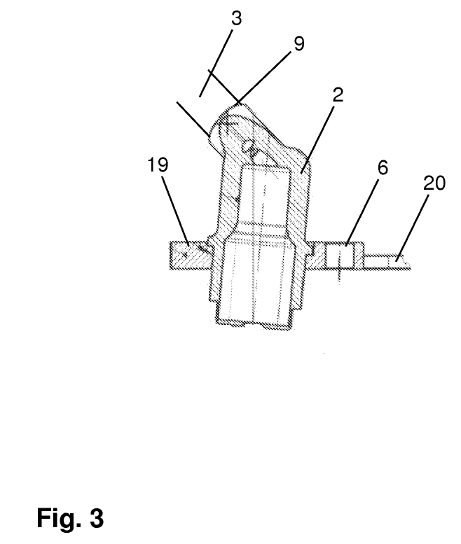

As is obvious from FIG. 2 and FIG. 3 in particular, the spacer 18 has sections 19, which receive the injectors 1 and/or mountings 2. The mountings 2 are preferably each inserted into and/or plugged through an opening of the section 19. The sections 19 preferably each have at least one through hole 6, through which a screw 7 can be plugged and screwed onto the internal combustion engine (not shown), in particular its cylinder head. The sections 19 preferably have two through holes 6 for the screw 7. Furthermore, a further through hole 6 can be provided, in which a pin 8 is provided for centering in relation to the cylinder head. The sections 19 for receiving the injectors 1 and/or mountings 2 are connected to one another by preferably weblike sections 20. Two weblike sections 20′, 20″, which form a frame, may be situated between adjacent sections 19′, 19″.

It can be that an adapter 21 is situated in each case between the injectors 1 and the mountings 2. The adapter 21 is preferably used for positioning the injector 1 in relation to the associated mounting 2. Additionally or alternatively, the adapter 21 can act as a spring element, which presses the injector 1 into the combustion chamber by spring force against the pressure of the combustion chamber.

In the component unit 100′, the fuel lines 3 are each inserted at one end into the mountings 2, and thus form a plug connection 9. The fuel lines 3 are connected at their other end by screw connections 10 to the fuel distributor 4. Due to the screw connections 10, the fuel distributor 4 is removable in relation to the units made of at least the fuel lines 3, the injectors 1, the mountings 2, and the spacer 18, so that the fuel distributor 4 itself together with at least the pressure sensor 12 and possible other components forms a separate pre-installable unit, in addition to the pre-installed component unit 100′. The provision of two completely installed and tested modules for the final assembly of the internal combustion engine is thus made possible. Soldering of the fuel lines 3 in relation to the mountings 2 or the fuel distributor 4 can be avoided in the embodiment of the component unit 100′.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A component unit for a fuel system of an internal combustion engine having direct injection with an injector adapted to inject fuel, comprising:
a mounting on which the injector is fixable;
a fuel line adapted for connection to a fuel distributor; and
a plug connection adapted to connect the fuel line to at least one of the injector or the mounting.

2. The component unit according to claim 1, wherein the plug connection utilizes a friction-lock.

3. The component unit according to claim 1, wherein the plug connection utilizes a formfitting.

4. The component unit according to claim 1, wherein the plug connection utilizes a glue.

5. The component unit according to claim 1, wherein the plug connection is formed by an end of the fuel line that is inserted into a receptacle.

6. The component unit according to claim 1, further comprising a positioning aid adapted to hold at least one of the injector or the mounting in a specified location.

7. The component unit according to claim 4, wherein the positioning is adapted to hold the injector or the mounting in a specified installation location with respect to the internal combustion engine.

8. The component unit according to claim 6, further comprising:
a second injector that injects fuel; and
a second mounting for the injector and the second injector;
wherein the positioning aid is adapted to hold the injector, the second injector, the mounting, and the second mounting at a specified distance to one another.

9. The component unit according to claim 6, wherein the positioning aid is fixable on the internal combustion engine through holes using pins that engage in the through holes.

10. The component unit according to claim 6, wherein the positioning aid comprises a spacer.

11. The component unit according to claim 10, wherein the spacer comprises sections that are adapted to receive the injector or the mounting.

12. The component unit according to claim 10, wherein a weblike section of the spacer lies between the injector and the mounting.

13. The component unit according to claim 10, wherein at least two weblike sections form a frame and lie between the sections for receiving the injector or mounting.

14. The component unit according to claim 6, wherein the injector or the mounting, the fuel line, the positioning aid are adapted to form a pre-installable unit.

15. The component unit according to claim 14, wherein the fuel distributor is a part of the pre-installable unit.

16. The component unit according to claim 1, wherein the injector and/or the at least one mounting, at least one fuel line, and optionally the fuel distributor are adapted to form a pre-installable unit.
